(19) United States
(12) Patent Application Publication
(10) Pub. No.: US 2026/0321891 A1
(43) Pub. Date: Oct. 15, 2026

(54) BATTERY CELL

(71) Applicants: TOYOTA JIDOSHA KABUSHIKI KAISHA, Toyota-shi (JP); Prime Planet Energy & Solutions, Inc., Tokyo (JP)

(72) Inventors: Masato ONO, Nagoya-shi (JP); Norihiro OSE, Nagoya-shi (JP); Yasuhiro SAKASHITA, Nisshin-shi (JP); Koichi YANASE, Nagoya-shi (JP); Takeru HARA, Toyota-shi (JP); Yuka YOKOI, Nagoya-shi (JP); Kohji UMEMURA, Okazaki-shi (JP); Toshiki IMABORI, Kasai-shi (JP); Yoshinori HIRANO, Nagoya-shi (JP); Satoshi FUJIMURA, Toki-shi (JP)

(73) Assignees: TOYOTA JIDOSHA KABUSHIKI KAISHA, Toyota-shi (JP); Prime Planet Energy & Solutions, Inc., Tokyo (JP)

(21) Appl. No.: 19/467,437

(22) Filed: Feb. 2, 2026

(30) Foreign Application Priority Data
Mar. 3, 2025 (JP) 2025-032975

(51) Int. Cl. H01M 50/474; H01M 10/04; H01M 10/0587; H01M 50/103; H01M 50/342; H01M 50/548; B60L 50/64

(52) U.S. Cl. CPC H01M 50/474; H01M 10/0431; H01M 10/0587; H01M 50/103; H01M 50/3425; H01M 50/548; B60L 50/64; H01M 2220/20

(57) ABSTRACT

A battery cell includes an electrode assembly, a housing case that houses the electrode assembly, and a porous member. The housing case includes a first wall extending in an extending direction, and a second wall in which a vent valve is provided. The porous member is disposed between the first wall and the electrode assembly and extends in the extending direction.

### CROSS-REFERENCE TO RELATED APPLICATION

This application claims priority to Japanese Patent Application No. 2025-032975 filed on Mar. 3, 2025. The disclosure of the above-identified application, including the specification, drawings, and claims, is incorporated by reference herein in its entirety.

### BACKGROUND

### 1. Technical Field

The present disclosure relates to battery cells.

### 2. Description of Related Art

Various types of energy storage cells have been proposed for use in energy storage devices mounted on vehicles. For example, Japanese Unexamined Patent Application Publication No. 2020-119810 (JP 2020-119810 A) discloses an energy storage cell (hereinafter referred to as "battery cell") including a housing case, an electrode assembly housed in the housing case, and a spacer disposed between the electrode assembly and the housing case. The spacer suppresses misalignment between the housing case and the electrode assembly.

### SUMMARY

The housing case of the battery cell disclosed in JP 2020-119810 A includes an upper plate, a bottom plate, and a peripheral wall that connects the upper plate and the bottom plate. A vent valve is provided in the upper plate. The spacer is disposed between the peripheral wall and the electrode assembly. The spacer forms a space between the electrode assembly and the peripheral wall. In such a battery cell, gas generated inside the housing case stagnates in the space formed between the electrode assembly and the peripheral wall. When the internal pressure of the housing case exceeds a prescribed value, the vent valve ruptures, and the gas that has stagnated in the space formed between the electrode assembly and the peripheral wall is forcefully discharged to the outside. Due to shear stress generated by the gas flow, a portion of the electrode assembly may be expelled to the outside of the housing case. If part of the electrode assembly comes into contact with outside air, compounds constituting the electrode assembly may react with air and generate heat.

The present disclosure has been made in view of the above issues, and an object thereof is to provide a battery cell capable of suppressing expulsion of a portion of an electrode assembly to the outside of a housing case when a vent valve formed in the housing case housing the electrode assembly ruptures.

A battery cell according to the present disclosure includes an electrode assembly, a housing case that houses the electrode assembly, and a porous member. The housing case includes a first wall extending in an extending direction, and a second wall in which a vent valve is provided. The porous member is disposed between the first wall and the electrode assembly and extends in the extending direction.

In the battery cell according to the present disclosure, an electrode terminal may be provided on the first wall. The electrode assembly may include a first end face facing the first wall and a current collector tab provided on the first end face. The current collector tab may be electrically connected to the electrode terminal. The porous member may be provided so as not to interfere with the current collector tab.

In the battery cell according to the present disclosure, the first wall may be located on the opposite side of the electrode assembly from the second wall.

In the battery cell according to the present disclosure, a direction in which the first wall and the second wall are arranged is defined as an arranging direction, and the electrode assembly may be a wound body provided around an imaginary winding axis extending in the arranging direction. The electrode assembly may include a first end face and a second end face arranged in the arranging direction, the first end face may face the first wall, and a hollow portion extending to the first end face and the second end face may be provided in the electrode assembly. The porous member may be disposed so as to close at least part of the hollow portion at the first end face.

The battery cell according to the present disclosure may further include a spacer made of a porous material. The spacer may be disposed between the electrode assembly and the second wall so as to provide a gap between the electrode assembly and the second wall, and may be spaced apart from the vent valve.

The battery cell according to the present disclosure can suppress expulsion of a portion of an electrode assembly to the outside of a housing case when a vent valve formed in the housing case housing the electrode assembly ruptures.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram showing a vehicle equipped with an energy storage device according to an embodiment of the present disclosure;

FIG. 2 is an exploded perspective view of the energy storage device according to the embodiment of the present disclosure;

FIG. 3 is an exploded perspective view of an energy storage cell according to the embodiment of the present disclosure;

FIG. 4 is an end view of a first electrode assembly housed in the energy storage cell of FIG. 3, as viewed in the direction of arrows IV-IV;

FIG. 5 is an enlarged view of a hollow portion shown in FIG. 4;

FIG. 6 is a sectional view of the energy storage cell shown in FIG. 2, taken along line VI-VI;

FIG. 7 is a sectional view of the energy storage cell shown in FIG. 2, taken along line VII-VII;

FIG. 8 is an enlarged exploded perspective view of a portion of the energy storage cell according to the embodiment of the present disclosure;

FIG. 9 is a sectional view of a first modification of the energy storage cell according to the embodiment of the present disclosure;

FIG. 10 shows a second modification of the energy storage cell according to the embodiment of the present disclosure; and

FIG. 11 is a sectional view of the energy storage cell shown in FIG. 10, taken along line XI-XI.

### DETAILED DESCRIPTION OF EMBODIMENTS

Hereinafter, an embodiment and modifications of the present disclosure will be described in detail with reference to the accompanying drawings. The same or corresponding portions are denoted by the same signs throughout the drawings, and description thereof will not be repeated.

### Embodiment

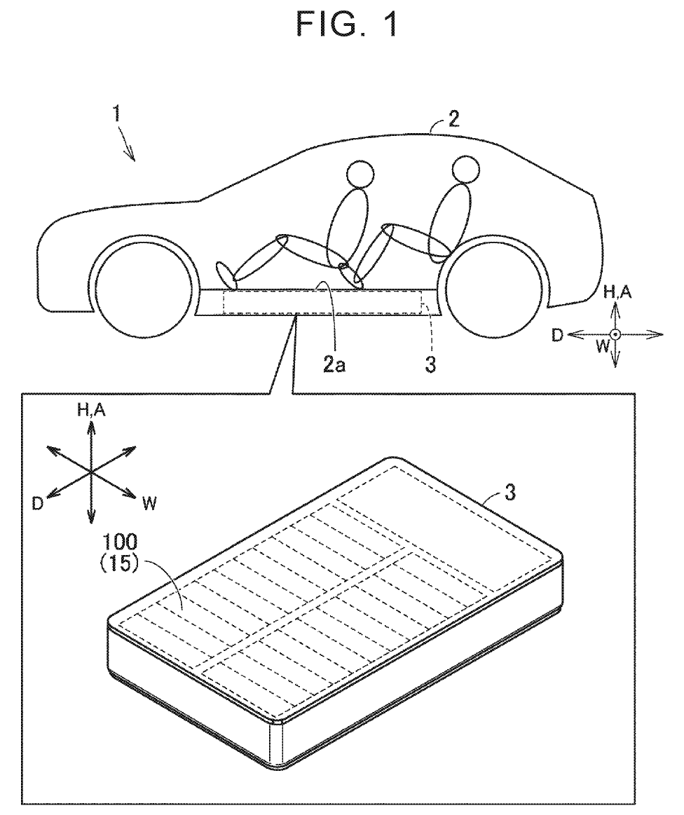

FIG. 1 is a schematic side view of a vehicle equipped with an energy storage device according to the embodiment. In FIG. 1, the up-down direction H indicates the up-down direction of a vehicle 1. The up-down direction H is the same as the axial direction A of an imaginary winding axis α of a first electrode assembly 81 that will be described later. The width direction W indicates the width direction of the vehicle 1. The front-rear direction D indicates the front-rear direction of the vehicle 1.

The vehicle 1 includes a vehicle body 2 and an energy storage device 3. The vehicle 1 may be, for example, a plug-in hybrid electric vehicle (PHEV), a battery electric vehicle (BEV), or a fuel cell electric vehicle (FCEV). The energy storage device 3 is disposed below a bottom portion 2a of the vehicle body 2.

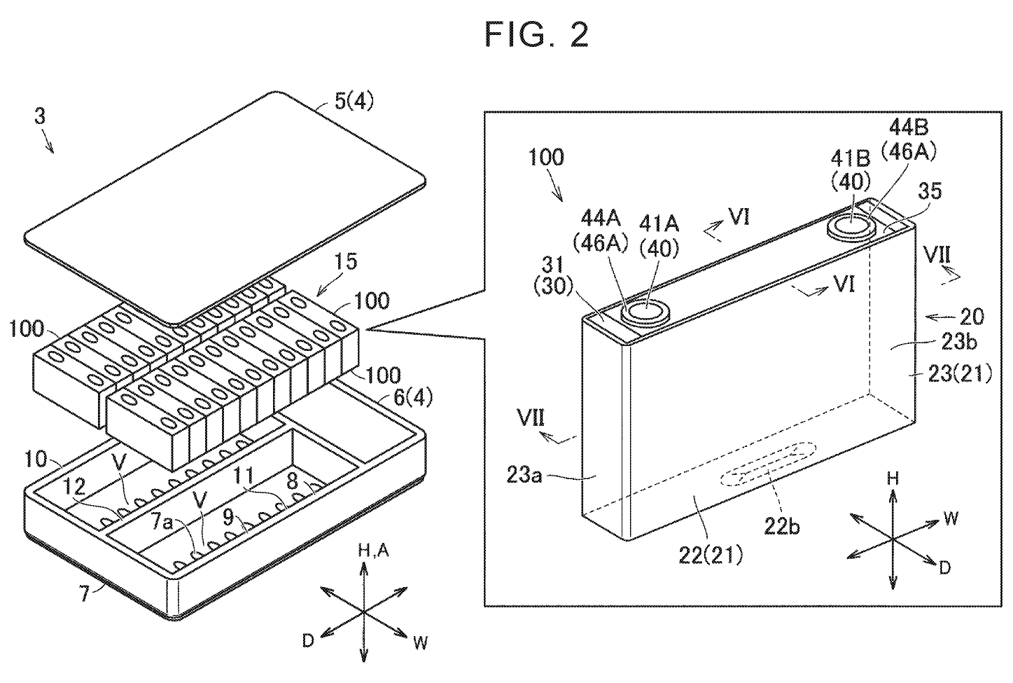

FIG. 2 is an exploded perspective view of the energy storage device according to the embodiment. The energy storage device 3 includes a housing case 4 and an energy storage stack 15.

The housing case 4 includes an upper cover 5 and a lower case 6. The housing case 4 forms a housing space V defined by the upper cover 5 and the lower case 6.

The upper cover 5 covers the lower case 6 that has an open top.

The lower case 6 includes a bottom wall 7 and a side wall 8. The bottom wall 7 supports the energy storage stack 15 in the up-down direction H. Openings 7a are formed in the bottom wall 7. Each opening 7a is located at a position facing a corresponding vent valve 22b that will be described later.

The side wall 8 extends upward from the bottom wall 7 in the up-down direction H. The side wall 8 includes a peripheral wall 9 and a reinforcing portion 12. The peripheral wall 9 is formed in a frame shape and extends upward from the outer peripheral edge of the bottom wall 7 in the up-down direction H. The peripheral wall 9 includes a first end wall 10 and a second end wall 11. The first end wall 10 and the second end wall 11 extend in the front-rear direction D and are spaced apart in the width direction W.

The reinforcing portion 12 extends in the front-rear direction D. The reinforcing portion 12 is disposed along the center in the width direction W between the first end wall 10 and the second end wall 11.

The energy storage stack 15 is housed in the housing space V and is disposed on the upper surface of the bottom wall 7. The energy storage stack 15 is formed from a plurality of energy storage cells 100. The energy storage cells 100 are arranged in the front-rear direction D. The energy storage cells 100 have a rectangular parallelepiped shape that is elongated in the width direction W. The energy storage cell 100 is an example of the "battery cell" of the present disclosure.

FIG. 2 also shows a perspective view of the energy storage cell 100. The energy storage cell 100 is a prismatic battery cell. The energy storage cell 100 may be a rechargeable secondary cell such as a lithium-ion cell or a nickel metal hydride cell.

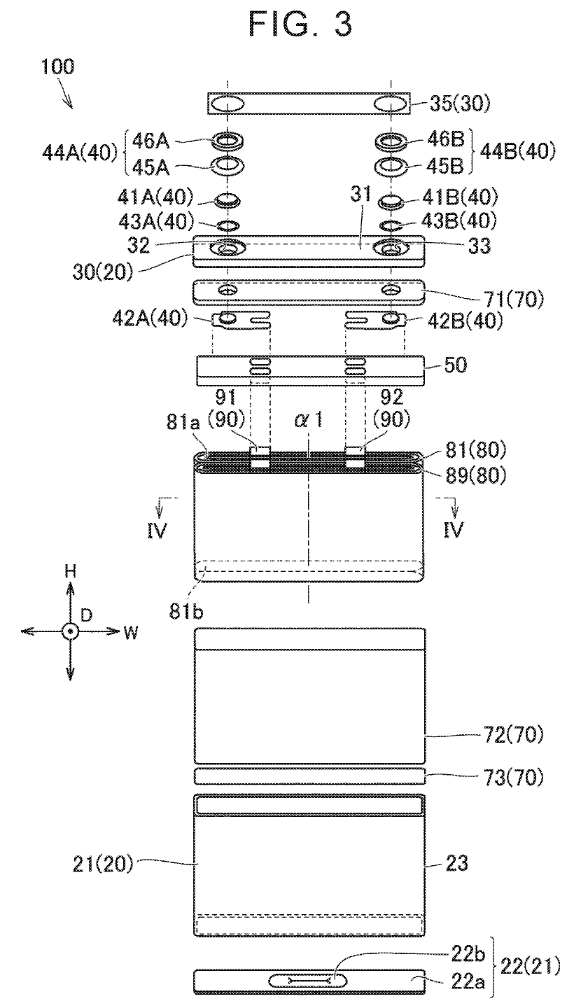

FIG. 3 is an exploded perspective view of the energy storage cell according to the present embodiment. As shown in FIG. 3, the energy storage cell 100 includes a housing case 20, a porous member 50, an insulating member 70, and a plurality of electrode assemblies 80.

The housing case 20 is electrically conductive. The housing case 20 is made of a metal such as aluminum. The housing case 20 houses the electrode assemblies 80. The housing case 20 also contains an electrolyte solution (not shown in FIG. 3). The housing case 20 includes a case body 21 and a top plate 30.

The case body 21 includes a bottom plate 22 and a peripheral wall 23 that stands from the bottom plate 22. The bottom plate 22 is joined to the peripheral wall 23 at the outer peripheral edge of the bottom plate 22. The bottom plate 22 includes a base plate 22a and a vent valve 22b. The bottom plate 22 is an example of the "second wall" of the present disclosure.

The vent valve 22b is formed in the base plate 22a. The vent valve 22b is a known type of vent valve. For example, Japanese Unexamined Patent Application Publication No. 2013-243075 (JP 2013-243075 A) discloses a vent valve 22b having a thinned portion formed to be thinner than the base plate 22a. A rupture groove is formed in the thinned portion of the vent valve 22b. By appropriately designing this groove, the vent valve 22b can be selectively ruptured by a slight increase in internal pressure of the housing case 20. The groove may be formed using, for example, a die and punch. The groove is formed in an elliptical or linear shape as viewed in plan in the up-down direction H.

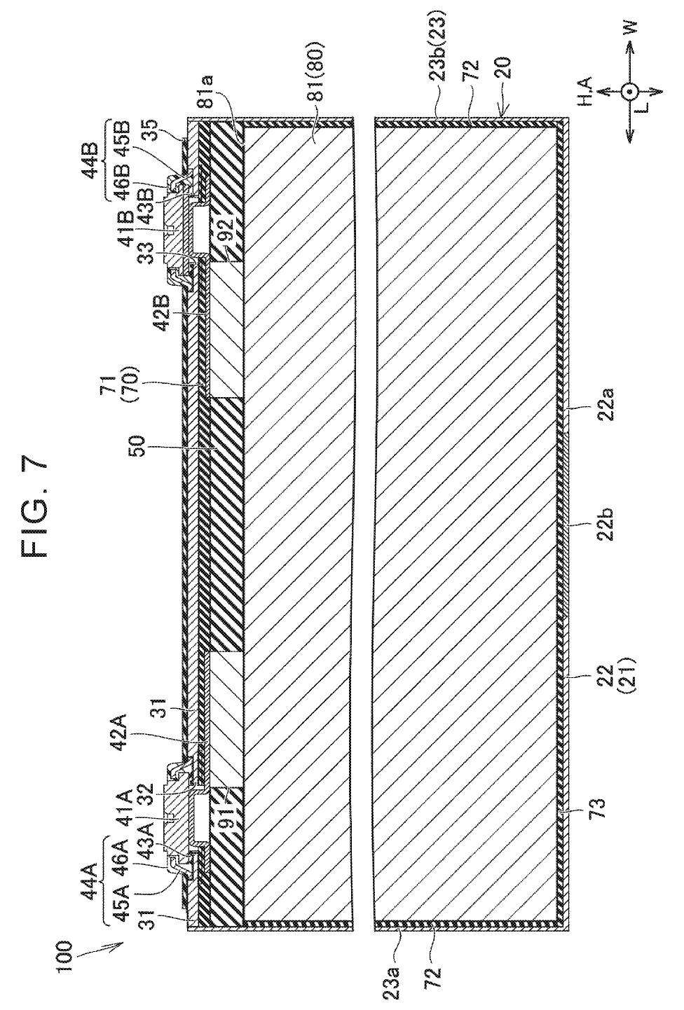

The peripheral wall 23 stands from the bottom plate 22. The peripheral wall 23 connects the bottom plate 22 and a top plate body 31 that will be described later. The peripheral wall 23 has a substantially rectangular outer shape as viewed in the up-down direction H. The peripheral wall 23 is made of a metal such as aluminum. As shown in FIG. 7, the peripheral wall 23 includes a first side wall 23a and a second side wall 23b. The first side wall 23a and the second side wall 23b are spaced apart in the width direction W.

Referring back to FIG. 3, the top plate 30 includes a top plate body 31, an insulating cover 35, and an electrode terminal 40.

The top plate body 31 extends in the width direction W so as to close the opening of the peripheral wall 23. The top plate body 31 is joined to the outer peripheral edge of the peripheral wall 23 by, for example, welding. The top plate body 31 is located on the opposite side of the electrode assemblies 80 from the bottom plate 22. In the embodiment of the present disclosure, the top plate body 31 and the bottom plate 22 are spaced apart in the up-down direction H. The top plate body 31 has a first connection hole 32 and a second connection hole 33. The top plate body 31 is an example of the "first wall" of the present disclosure.

The insulating cover 35 covers the outer surface of the top plate body 31.

The electrode terminal 40 is provided on the top plate body 31. The electrode terminal 40 includes a first external terminal 41A, a second external terminal 41B, a connecting member 42, a first seal ring 43A, a second seal ring 43B, a first terminal support portion 44A, and a second terminal support portion 44B.

The first external terminal 41A and the second external terminal 41B are provided so as to be exposed to the outside of the energy storage cell 100.

The connecting member 42 is electrically conductive. The connecting member 42 includes a first connecting member 42A and a second connecting member 42B. The first connecting member 42A and the second connecting member 42B are disposed with at least part of each located inside the housing case 20.

The first external terminal 41A or the first connecting member 42A is inserted through the first connection hole 32. The first external terminal 41A and the first connecting member 42A are joined to each other. The first connecting member 42A is electrically connected to the electrode assemblies 80. Accordingly, the first external terminal 41A is electrically connected to the electrode assemblies 80.

The second external terminal 41B or the second connecting member 42B is inserted through the second connection hole 33. The second external terminal 41B and the second connecting member 42B are joined to each other. The second connecting member 42B is electrically connected to the electrode assemblies 80. Accordingly, the second external terminal 41B is electrically connected to the electrode assemblies 80.

The first seal ring 43A is provided along the first connection hole 32. The first seal ring 43A is disposed in a gap between the top plate body 31 and the first external terminal 41A, and seals this gap. The second seal ring 43B is provided along the second connection hole 33. The second seal ring 43B is disposed in a gap between the top plate body 31 and the second external terminal 41B, and seals this gap. The first seal ring 43A and the second seal ring 43B are electrically insulating.

The first terminal support portion 44A is retained on the top plate body 31. The first terminal support portion 44A supports the first external terminal 41A from the outer periphery of the first external terminal 41A. The first terminal support portion 44A includes a first retaining ring 45A and a first covering ring 46A. The first retaining ring 45A extends annularly so as to surround the first connection hole 32, and is directly retained on the top plate body 31. The first covering ring 46A covers the first retaining ring 45A. The first retaining ring 45A supports the first external terminal 41A via the first covering ring 46A. The first covering ring 46A is an electrically insulating resin member.

The second terminal support portion 44B is retained on the top plate body 31. The second terminal support portion 44B supports the second external terminal 41B from the outer periphery of the second external terminal 41B. The second terminal support portion 44B includes a second retaining ring 45B and a second covering ring 46B. The second retaining ring 45B extends annularly so as to surround the second connection hole 33, and is directly retained on the top plate body 31. The second covering ring 46B covers the second retaining ring 45B. The second retaining ring 45B supports the second external terminal 41B via the second covering ring 46B. The second covering ring 46B is an electrically insulating resin member.

The insulating member 70 is electrically insulating. The insulating member 70 is disposed between the electrode assemblies 80 and the housing case 20. The insulating member 70 electrically insulates the electrode assemblies 80 from the housing case 20. The insulating member 70 includes an insulating bracket 71, a peripheral surface insulating portion 72, and a bottom surface insulating portion 73.

The insulating bracket 71 is disposed between the electrode assemblies 80 and the top plate body 31. The insulating bracket 71 is in contact with the top plate body 31. The peripheral surface insulating portion 72 is disposed between the electrode assemblies 80 and the peripheral wall 23. The peripheral surface insulating portion 72 is a member in the form of a film. The bottom surface insulating portion 73 is disposed between the electrode assemblies 80 and the bottom plate 22. The bottom surface insulating portion 73 is a member in the form of a film. In the present embodiment, the bottom surface insulating portion 73 is bonded to the electrode assemblies 80.

The electrode assemblies 80 are wound electrode assemblies. The electrode assemblies 80 typically include a first electrode assembly 81 and a second electrode assembly 89. The first electrode assembly 81 and the second electrode assembly 89 are arranged adjacent to each other in the front-rear direction D. The peripheral surface insulating portion 72 may integrally cover the electrode assemblies 80 such that the first electrode assembly 81 and the second electrode assembly 89 are fixed to each other. Since the second electrode assembly 89 has substantially the same configuration as the first electrode assembly 81, detailed description of the second electrode assembly 89 will be omitted.

The first electrode assembly 81 has a first end face 81a and a second end face 82a that are spaced apart in the up-down direction H. The first end face 81a faces the top plate body 31. The second end face 82a faces the bottom plate 22. The first electrode assembly 81 includes current collector tabs 90. The current collector tabs 90 are provided on the first end face 81a. The current collector tabs 90 include a first current collector tab 91 and a second current collector tab 92. The first current collector tab 91 electrically connects a first electrode sheet 82 (described later) of the first electrode assembly 81 to the first connecting member 42A. Similarly, the second current collector tab 92 electrically connects a second electrode sheet 83 (described later) of the first electrode assembly 81 to the second connecting member 42B.

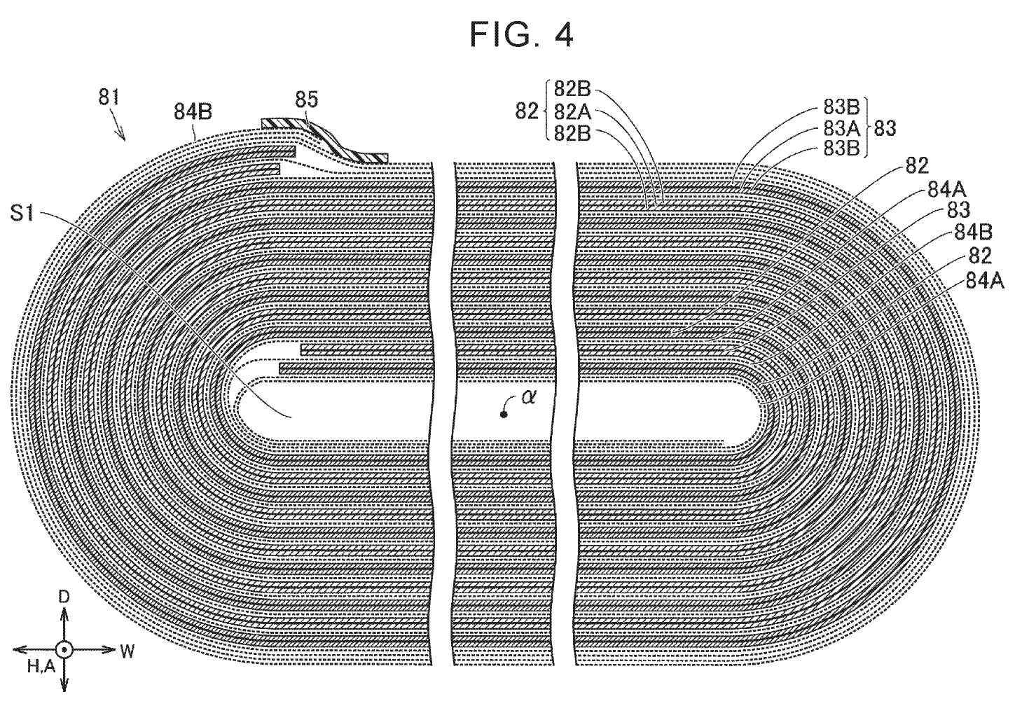

The first electrode assembly 81 will now be described in detail with reference to FIG. 4. FIG. 4 is an end view of the first electrode assembly 81 housed in the energy storage cell 100 of FIG. 3, as viewed in the direction of arrows IV-IV.

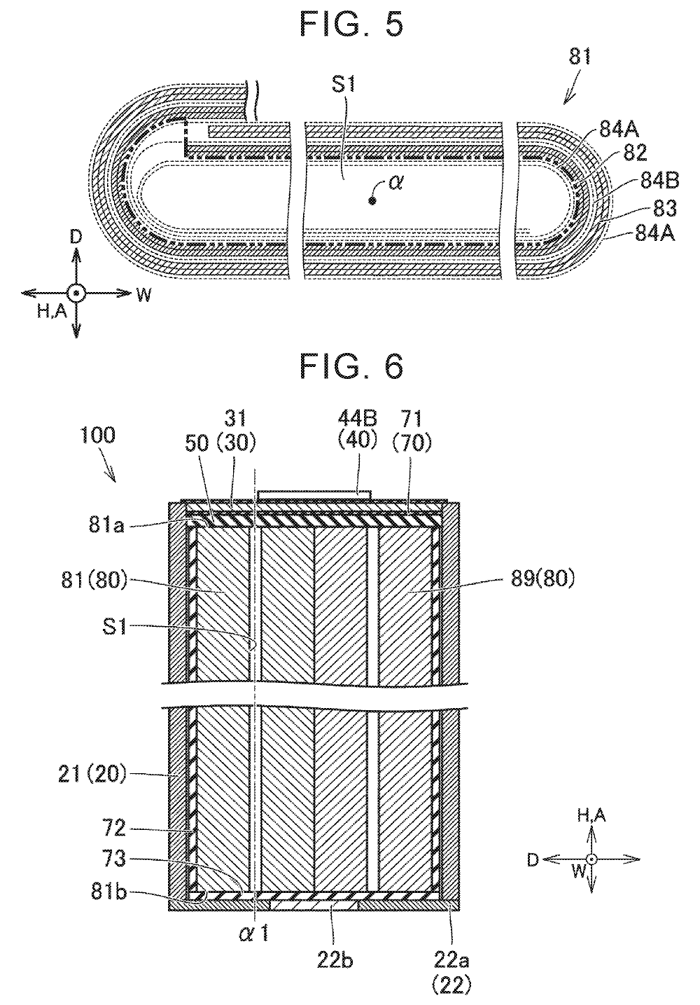

The first electrode assembly 81 includes a first electrode sheet 82, a second electrode sheet 83, a first separator 84A, a second separator 84B, and a tape member 85. The first electrode sheet 82, the second electrode sheet 83, the first separator 84A, and the second separator 84B each have a sheet-like outer shape. The first electrode sheet 82, the second electrode sheet 83, the first separator 84A, and the second separator 84B are collectively referred to as "sheet group." The first electrode assembly 81 is formed by winding the first electrode sheet 82 and the second electrode sheet 83 with the first separator 84A and the second separator 84B interposed therebetween around an imaginary winding axis α. That is, the first electrode assembly 81 is a wound electrode assembly. The imaginary winding axis α is the axis of the first electrode assembly 81 that extends in the axial direction A. In the embodiment of the present disclosure, the axial direction A is the same as the up-down direction H. The first electrode assembly 81 is formed such that, from the inner peripheral side closest to the imaginary winding axis α, the first separator 84A, the first electrode sheet 82, the second separator 84B, and the second electrode sheet 83 are sequentially wound in this order around the imaginary winding axis α. A hollow portion S is formed in the first electrode assembly 81. More specifically, as shown in FIG. 5, the first electrode sheet 82 is positioned on the inner peripheral side closer to the imaginary winding axis α than the second electrode sheet 83, and the hollow portion S is defined by the innermost first electrode sheet 82 closest to the imaginary winding axis α. The up-down direction is an example of the "arrangement direction" in the present disclosure.

Referring back to FIG. 4, the first electrode sheet 82 includes a first current collector 82A and a first active material layer 82B. The second electrode sheet 83 includes a second current collector 83A and a second active material layer 83B. In the present embodiment, the first electrode sheet 82 serves as a positive electrode, and the second electrode sheet 83 serves as a negative electrode. However, the first electrode sheet 82 may serve as a negative electrode and the second electrode sheet 83 may serve as a positive electrode.

The first separator 84A and the second separator 84B separate the first electrode sheet 82 and the second electrode sheet 83 while allowing ions to travel between the first electrode sheet 82 and the second electrode sheet 83. The ions may be, for example, lithium ions. The first separator 84A and the second separator 84B are electrically insulating. The first separator 84A is positioned on the innermost peripheral side with respect to the imaginary winding axis α. The second separator 84B is positioned on the outermost peripheral side with respect to the imaginary winding axis α. The outermost peripheral edge of the second separator 84B is fixed by the tape member 85 disposed on the outer peripheral surface of the second separator 84B.

FIG. 6 is a sectional view of the energy storage cell shown in FIG. 2, taken along line VI-VI. The hollow portion S extends from the first end face 81a to the second end face 81b around the imaginary winding axis α. The porous member 50 is disposed so as to close the hollow portion S at the first end face 81a. More specifically, the porous member 50 is disposed between the electrode assemblies 80 and the top plate body 31, and covers the hollow portion S. The porous member 50 may alternatively be configured to cover part of the hollow portion S.

FIG. 7 is a sectional view of the energy storage cell shown in FIG. 2, taken along line VII-VII. The energy storage cell 100 includes the porous member 50. The porous member 50 is disposed between the top plate body 31 and the electrode assemblies 80. The porous member 50 is made of a porous material. The porous member 50 extends in the width direction W along the top plate body 31. More specifically, both ends of the porous member 50 in the width direction W reach the first side wall 23a and the second side wall 23b, respectively. The width direction W is an example of the "extending direction" in the present disclosure.

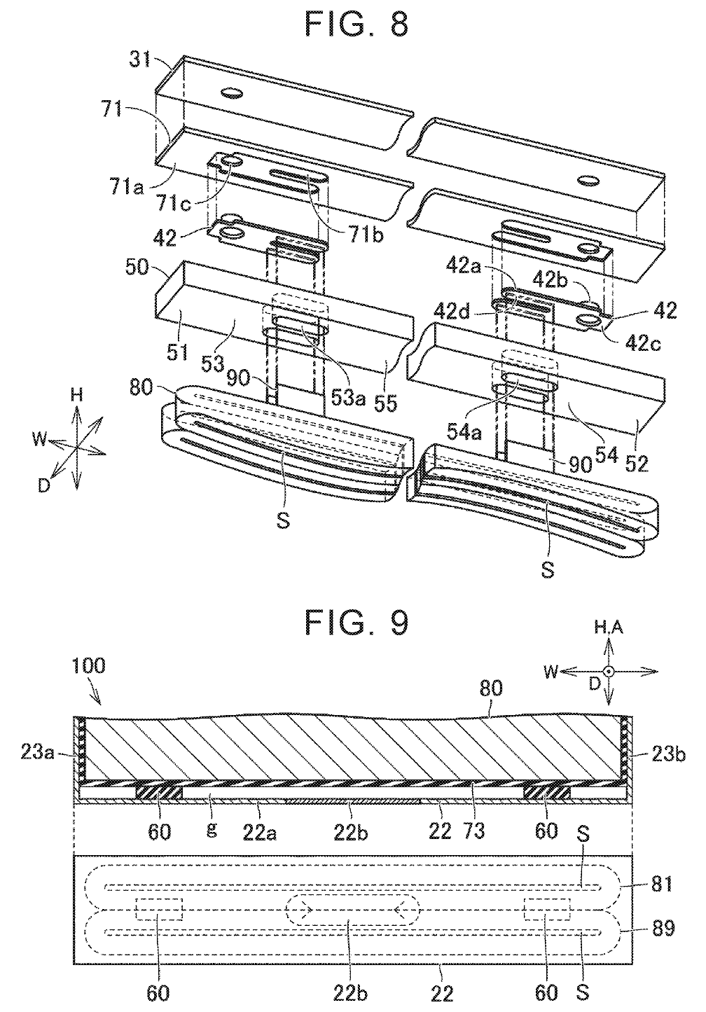

FIG. 8 is an enlarged exploded perspective view of a portion of the energy storage cell. In FIG. 8, the top plate body 31, the connecting member 42, the porous member 50, the insulating bracket 71, and the electrode assemblies 80 are illustrated, and other components are omitted.

The connecting member 42, the insulating bracket 71, and the porous member 50 will now be described in detail with reference to FIG. 8.

The connecting member 42 includes a main body 42a and a protruding portion 42b. The main body 42a has a bottom surface 42c. The bottom surface 42c includes a joining region 42d. In the joining region 42d, the current collector tabs 90 are joined to the connecting member 42 by, for example, ultrasonic welding.

The insulating bracket 71 includes a bottom surface 71a, a housing portion 71b, and a through hole 71c. The housing portion 71b is formed as a recess in the bottom surface 71a and extends in the up-down direction H from the bottom surface 71a toward the top plate 30. The housing portion 71b is formed so as to conform to the shape of the connecting member 42. The connecting member 42 is housed in the housing portion 71b in the up-down direction H from the porous member 50 toward the insulating bracket 71. When the insulating bracket 71 is viewed in plan from the top plate 30 side in the up-down direction H, the protruding portion 42b of the connecting member 42 protrudes toward the top plate 30 through the through hole 71c. When the connecting member 42 is housed in the housing portion 71b, the bottom surface 42c of the connecting member 42 and the bottom surface 71a of the insulating bracket 71 are flush with each other.

The porous member 50 is disposed between the insulating bracket 71 and the electrode assemblies 80. The porous member 50 extends in the width direction W and is configured so as not to interfere with the current collector tabs 90. More specifically, the porous member 50 includes end portions 51, 52, clearance portions 53, 54, and a connecting portion 55. The end portion 51 is located at one end of the porous member 50 in the width direction W, and the end portion 52 is located at the other end of the porous member 50 in the width direction W. The clearance portions 53, 54 face the connecting member 42 in the up-down direction H, and have clearance holes 53a, 54a, respectively. When the porous member 50 is viewed in plan from the side of the electrode assemblies 80 in the up-down direction H, the clearance holes 53a, 54a are formed along the joining region 42d. The porous member 50 is formed with the clearance holes 53a, 54a such that the current collector tabs 90 provided on the electrode assemblies 80 can reach the connecting member 42 located on the opposite side of the porous member 50 from the electrode assemblies 80. The connecting portion 55 connects the clearance portion 53 and the clearance portion 54.

In the embodiment of the present disclosure, each energy storage cell 100 includes electrode assemblies 80, a housing case 20 that houses the electrode assemblies 80, and a porous member 50. The housing case 20 includes a bottom plate 22 and a top plate body 31. A vent valve 22b is formed in the bottom plate 22. The top plate body 31 extends in the width direction W. The porous member 50 is disposed between the electrode assemblies 80 and the top plate body 31. The porous member 50 extends in the width direction W.

When the pressure inside the housing case exceeds a prescribed value, the vent valve ruptures, and gas is forcefully discharged to the outside of the housing case. At this time, gas that has stagnated in a region away from the vent valve may carry away a portion of the electrode assembly along the path from the stagnation region to the vent valve and expel the portion of the electrode assembly to the outside of the housing case. The energy storage cell 100 makes it less likely that gas generated inside the housing case 20 stagnates in a region where the porous member 50 is disposed. As a result, the energy storage cell 100 can suppress expulsion of a portion of the electrode assembly to the outside of the housing case 20. In addition, since the porous member 50 is made of a porous material, it absorbs excess electrolyte solution inside the housing case 20 and suppresses discharge of the electrolyte solution to the outside when the vent valve 22b ruptures.

In the embodiment of the present disclosure, the electrode terminal 40 is provided on the top plate body 31. Each electrode assembly 80 has a first end face 81a that faces the top plate body 31. The current collector tabs 90 are provided on the first end face 81a. The current collector tabs 90 are electrically connected to the electrode terminal 40. The porous member 50 has clearance holes 53a, 54a. The current collector tabs 90 provided on the first end face 81a are electrically connected to the electrode terminal 40 through the clearance holes 53a, 54a.

A space is formed between the electrode assemblies 80 and the connecting member 42 because of the presence of the current collector tabs 90. The porous member 50 is disposed in this space. This can suppress an increase in the size of the energy storage cell due to securing installation space for the porous member 50.

In the embodiment of the present disclosure, the top plate body 31 adjacent to the porous member 50 is located on the opposite side of the electrode assemblies 80 from the bottom plate 22 in which the vent valve 22b is formed.

In the energy storage cell 100 having such a configuration, the porous member 50 is located on the opposite side of the electrode assemblies 80 from the vent valve 22b. Accordingly, gas generated inside the housing case 20 is less likely to stagnate on the opposite side of the electrode assemblies 80 from the vent valve 22b. As a result, when the vent valve 22b ruptures, a portion of the electrode assembly 80 is less likely to be carried away and expelled to the outside of the housing case 20 by gas that passes through the electrode assembly 80 when the gas is discharged to the outside of the housing case 20.

In the embodiment of the present disclosure, the electrode assemblies 80 are wound bodies formed around an imaginary winding axis α extending in the axial direction A that is the same as the vertical direction H. Each of the electrode assemblies 80 has a first end face 81a and a second end face 81b. The first end face 81a and the second end face 81b are arranged in the up-down direction. A hollow portion S is formed in each of the electrode assemblies 80. The hollow portion S extends to the first end face 81a and the second end face 81b. The porous member 50 is disposed so as to close the hollow portion S at the first end face 81a.

In the energy storage cell 100 having such a configuration, the porous member 50 makes it less likely that gas generated inside the electrode assembly 80 reaches the region between the first end face 81a and the top plate body 31 through the hollow portion S.

In the embodiment of the present disclosure, the top plate body 31 and the bottom plate 22 are spaced apart in the up-down direction H. The top plate body 31 is located closer to the bottom portion 2a than the bottom plate 22. The vent valve 22b is formed in the bottom plate 22.

In the vehicle 1, the vent valve 22b faces toward the ground. With such a configuration, the energy storage cell 100 makes it less likely that gas discharged from the vent valve 22b enters the vehicle body 2.

In the embodiment of the present disclosure, the porous member 50 is formed so as not to interfere with the current collector tabs 90. As a specific example of this structure, the clearance holes 53a, 54a are formed in the porous member 50 along the joining region 42d. However, the present disclosure is not limited to this example. For example, when the porous member 50 is viewed in plan from the side of the electrode assemblies 80 in the up-down direction H, the clearance holes 53a, 54a may be formed along the outer peripheral edge of the connecting member 42. Although an example has been illustrated in which the porous member 50 includes the end portions 51, 52, the clearance portions 53, 54, and the connecting portion 55, the porous member 50 may not include the clearance portions 53, 54. Alternatively, the porous member 50 may be formed from at least part of the end portions 51, 52, the clearance portions 53, 54, and the connecting portion 55.

### First Modification

FIG. 9 shows a first modification of the energy storage cell according to the embodiment of the present disclosure. As shown in FIG. 9, the energy storage cell 100 may further include a spacer 60. The spacer 60 is made of a porous material. The spacer 60 is disposed between the electrode assemblies 80 and the bottom plate 22. When the bottom plate 22 is viewed in plan in the up-down direction H, the spacer 60 is spaced apart from the vent valve 22b and is also spaced apart from the hollow portion S.

In the energy storage cell 100 having such a configuration, the spacer 60 forms a gap g between the electrode assemblies 80 and the bottom plate 22. Gas generated inside the housing case 20 stagnates in the gap g. When the vent valve 22b ruptures, the gap g communicates with the outside of the housing case 20. As a result, a portion of the electrode assembly 80 is less likely to be carried away and expelled to the outside of the housing case 20 by the gas when the gas is discharged to the outside of the housing case 20.

The spacer 60 is made of a porous material. Accordingly, the spacer 60 absorbs the excess electrolyte solution sealed inside the housing case 20. As a result, the electrolyte solution inside the housing case 20 is less likely to be carried away and expelled to the outside of the housing case 20 by the gas when the gas is discharged to the outside of the housing case 20.

### Second Modification

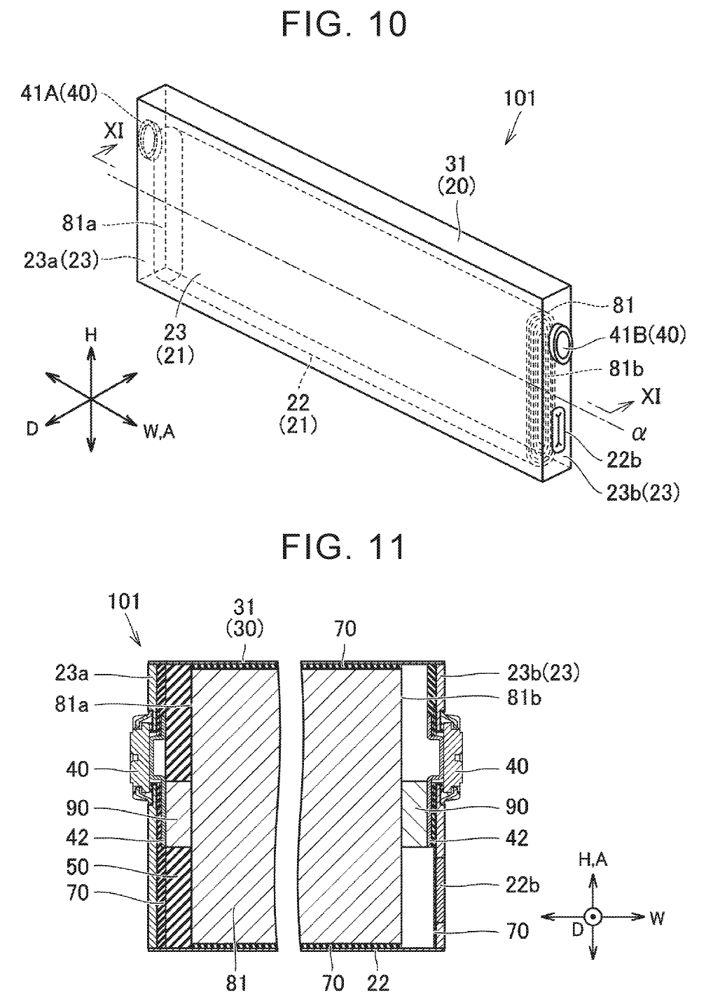

FIG. 10 shows a second modification of the energy storage cell according to the embodiment of the present disclosure. An energy storage cell 101, which is the second modification of the energy storage cell 100, has substantially the same configuration as the energy storage cell 100 unless otherwise specified below.

As shown in FIG. 10, the first side wall 23a and the second side wall 23b of the energy storage cell 101 are spaced apart in the width direction W. The first side wall 23a and the second side wall 23b extend in the up-down direction H. The electrode terminal 40 is provided on each of the first side wall 23a and the second side wall 23b. The vent valve 22b is formed in the second side wall 23b. In the energy storage cell 101, the axial direction A of the imaginary winding axis α is the same as the width direction W. The first side wall 23a corresponds to the "first wall" in the present disclosure. The second side wall 23b corresponds to the "second wall" in the present disclosure. The up-down direction H is an example of the "extending direction" in the present disclosure. The width direction W is an example of the "arranging direction" in the present disclosure.

FIG. 11 is a sectional view of the energy storage cell 101 shown in FIG. 10, taken along line XI-XI. The first side wall 23a is located on the opposite side of the first electrode assembly 81 from the second side wall 23b. The first electrode assembly 81 has a first end face 81a and a second end face 81b. The first end face 81a faces the first side wall 23a. A current collector tab 90 is provided on the first end face 81a. The porous member 50 is disposed between the first side wall 23a and the first electrode assembly 81. The porous member 50 extends in the up-down direction H. The porous member 50 is formed so as not to interfere with the current collector tab 90.

In the energy storage cell 101 having such a configuration, the porous member 50 is located on the opposite side of the first electrode assembly 81 from the vent valve 22b. Accordingly, gas generated inside the housing case 20 is less likely to stagnate on the opposite side of the first electrode assembly 81 from the vent valve 22b. As a result, when the vent valve 22b ruptures, a portion of the first electrode assembly 81 is less likely to be carried away and expelled to the outside of the housing case 20 by gas that passes through the first electrode assembly 81 when the gas is discharged to the outside of the housing case 20.

Although the embodiment of the present disclosure has been described above, the embodiment disclosed herein should be considered to be illustrative in all respects and not restrictive. The technical scope of the present disclosure is defined by the claims, and is intended to include all modifications within the meaning and scope equivalent to the claims.

What is claimed is:

1. A battery cell comprising:
an electrode assembly;
a housing case that houses the electrode assembly; and
a porous member, wherein:
the housing case includes a first wall extending in an extending direction, and a second wall in which a vent valve is provided; and
the porous member is disposed between the first wall and the electrode assembly and extends in the extending direction.

2. The battery cell according to claim 1, wherein:
an electrode terminal is provided on the first wall;
the electrode assembly includes a first end face facing the first wall and a current collector tab provided on the first end face;
the current collector tab is electrically connected to the electrode terminal; and
the porous member is provided so as not to interfere with the current collector tab.

3. The battery cell according to claim 1, wherein the first wall is located on an opposite side of the electrode assembly from the second wall.

4. The battery cell according to claim 3, wherein:
a direction in which the first wall and the second wall are arranged is defined as an arranging direction;
the electrode assembly is a wound body provided around an imaginary winding axis extending in the arranging direction;
the electrode assembly includes a first end face and a second end face arranged in the arranging direction;
the first end face faces the first wall;
a hollow portion extending to the first end face and the second end face is provided in the electrode assembly; and
the porous member is disposed so as to close at least part of the hollow portion at the first end face.

5. The battery cell according to claim 1, further comprising a spacer made of a porous material,
wherein the spacer is disposed between the electrode assembly and the second wall so as to provide a gap between the electrode assembly and the second wall, and is spaced apart from the vent valve.
